(19) United States
(12) Patent Application Publication
(10) Pub. No.: US 2017/0147609 A1
(43) Pub. Date: May 25, 2017

(54) METHOD FOR ANALYZING AND SEARCHING 3D MODELS

(71) Applicant: NATIONAL CHIAO TUNG UNIVERSITY, Hsinchu City (TW)

(72) Inventors: I-Chen LIN, Hsinchu City (TW); Jun-Yang LIN, New Taipei City (TW); Mei-Fang SHE, Kaohsiung City (TW); Wen-Hsiang TSAI, Hsinchu City (TW)

(21) Appl. No.: 15/149,182

(22) Filed: May 9, 2016

(30) Foreign Application Priority Data
Nov. 19, 2015 (TW) 104138313

(51) Int. Cl. G06F 17/30; G06K 9/52; G06K 9/46

(52) U.S. Cl. CPC G06F 17/30256; G06K 9/4642; G06K 9/522; G06K 9/525; G06K 2009/4666

(57) ABSTRACT

A method for analyzing and searching 3D models includes steps of obtaining data global features and data local features of data images by globally analyzing and locally analyzing data images of 3D models respectively; obtaining searching global features and searching local features by globally analyzing and locally analyzing searching images respectively; obtaining corresponding data global features and corresponding data local features based on the search global features and the searching local feature; and obtaining corresponding data images based on the corresponding data global features and the corresponding data local features.

### RELATED APPLICATIONS

This application claims priority to Taiwan Application Serial Number 104138313, filed Nov. 19, 2015, which is herein incorporated by reference.

### BACKGROUND

Field of Invention

The present invention relates to a method for analyzing and searching images. More particularly, the present invention relates to a method for analyzing and searching 3D models based on global features and local features.

Description of Related Art

Existing 3D model searching systems can perform comparison searching by using sketches, images or even by inputting 3D models. Most 3D model searching systems assume that the target models are rigid bodies. In addition, the sketches and images inputted into the 3D model searching systems are typically in the form of front views and lateral views perpendicular to the front views.

However, not every object has rigid-body properties. For example, the human body has many movable joints. When users search for human models, if the positions of the arms or legs of the inputted human body are different from those in the database, or the inputted images are not front views and lateral views (e.g., the inputted images are perspective views), the searching results of such existing 3D model searching systems are commonly contrary to what was expected by users.

The cause for the discrepancy discussed above relates to how the existing technology often analyzes the inputted data by global feature to perform a comparison with the model stored in the database. If it is supposed that the inputted models have movable joints, even though they are the same models, when the models are in different poses, their projected views are different. Therefore, it is hard to find correct models, and the accuracy of the searching result is decreased.

In view of the foregoing, problems and disadvantages are associated with existing products that require further improvement. However, those skilled in the art have yet to find a solution.

### SUMMARY

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a method for analyzing and searching images. The method comprises steps of obtaining a plurality of data global features and a plurality of data local features of a plurality of data images by globally analyzing and locally analyzing the data images respectively; obtaining a searching image; obtaining a searching global feature and a searching local feature of the searching image by globally analyzing and locally analyzing the searching image respectively; obtaining a corresponding data global feature from the data global features based on the searching global feature, and obtaining a corresponding data local feature from the data local features based on the searching local feature; and obtaining a corresponding data image from the data images based on the corresponding data global feature and the corresponding data local feature.

In view of the foregoing, embodiments of the present disclosure provide a method for analyzing and searching images to improve the problem of the searching result of existing 3D model searching systems being contrary to the searching result expected by users.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a flow diagram illustrating process steps of a method for analyzing and searching images according to embodiments of the present disclosure.

FIG. 2 is a flow diagram illustrating process steps of analyzing images of the method for analyzing and searching images as shown in FIG. 1 according to embodiments of the present disclosure.

FIG. 3 is a flow diagram illustrating process steps of searching images of the method for analyzing and searching images as shown in FIG. 1 according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

For solving the problem related to inaccuracy of searching results due to using global features to analyze input data and compare with database models, the present disclosure provides a method for analyzing and searching images, which will be described below.

The present disclosure is directed to a method for analyzing and searching images for solving the problem related to inaccuracy of searching results due to using global features to analyze input data and compare with models stored in a database.

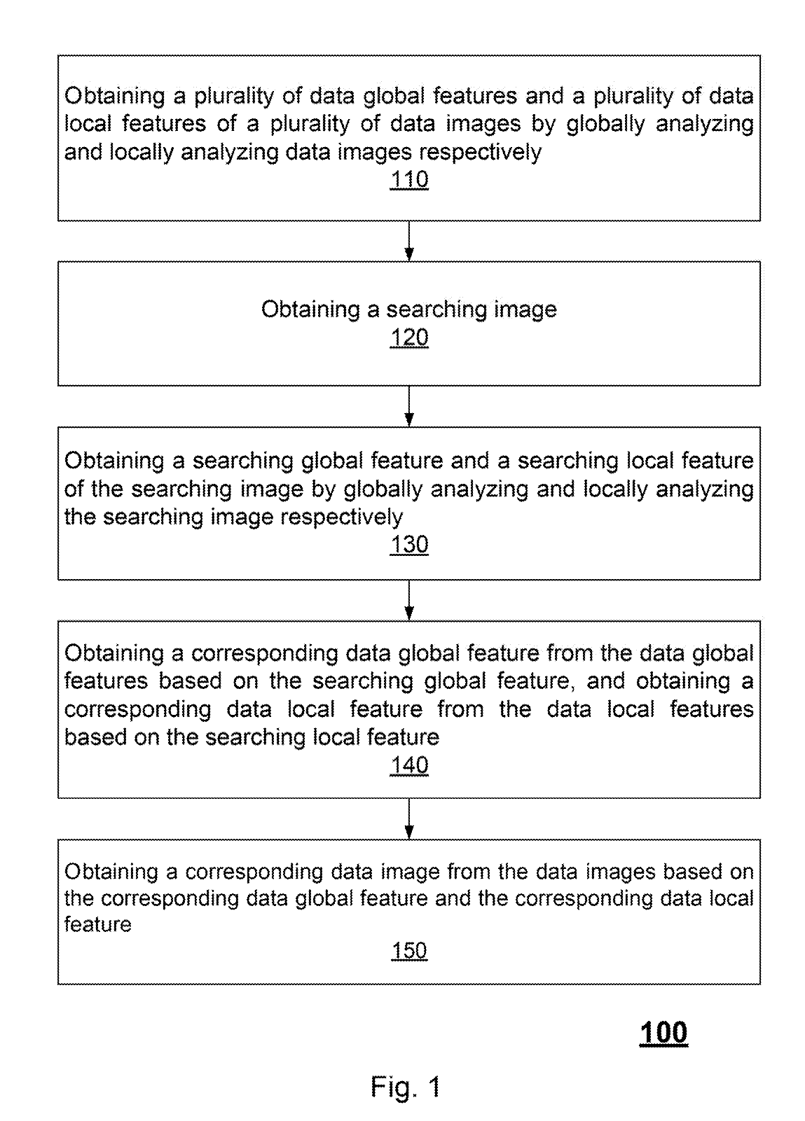

FIG. 1 is a flow diagram illustrating process steps of a method for analyzing and searching images according to embodiments of the present disclosure. As shown in the figure, the method 100 for analyzing and searching images comprises steps as follows:

Step 110: obtaining a plurality of data global features and a plurality of data local features of a plurality of data images by globally analyzing and locally analyzing the data images respectively;

Step 120: obtaining a searching image;

Step 130: obtaining a searching global feature and a searching local feature of the searching image by globally analyzing and locally analyzing the searching image respectively;

Step 140: obtaining a corresponding data global feature from the data global features based on the searching global feature, and obtaining a corresponding data local feature from the data local features based on the searching local feature; and

Step 150: obtaining a corresponding data image from the data images based on the corresponding data global feature and the corresponding data local feature.

Steps 110˜150 of the method 100 for analyzing and searching images of the present disclosure is used to establish an off-line database for users to do on-line searching.

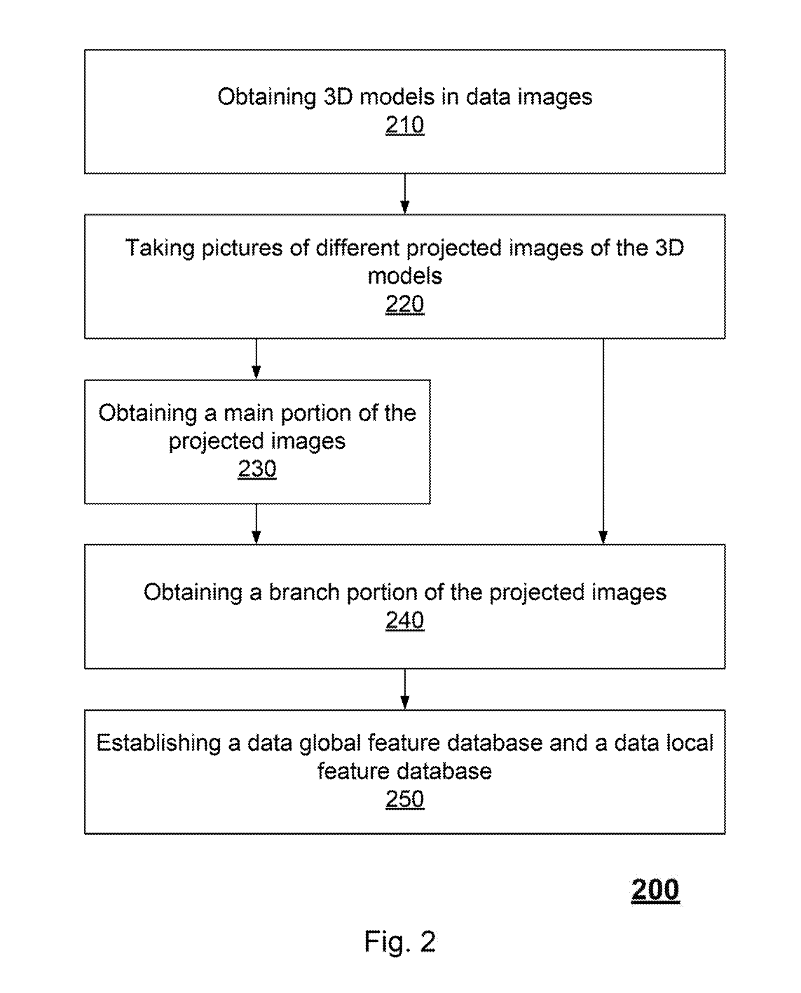

For facilitating understanding of how to establish the off-line database, reference is made to step 110 of FIG. 1, and to FIG. 2. FIG. 2 is a flow diagram illustrating process steps of analyzing images of the method 100 for analyzing and searching images as shown in FIG. 1 according to embodiments of the present disclosure. First of all, in step 110, the method of the present disclosure globally analyzes and locally analyzes the data images which are stored in the database originally for correspondingly obtaining a plurality of data global features and a plurality of data local features of a plurality of data images. In one embodiment, the method of the present disclosure obtains and analyzes a plurality of projected images of the data images stored in the original database in different viewpoints. As shown in step 210 of FIG. 2, the method of the present disclosure obtains 3D models comprised by the data images, and places 3D models at a center of a regular polyhedron. Subsequently, in step 220, the method of the present disclosure takes pictures of different projected images of the 3D models at a plurality of vertexes of the regular polyhedron. For example, the regular polyhedron may be a regular dodecahedron, but is not limited thereto. The method of the present disclosure places the 3D models of the data images at a center of the regular dodecahedron. Subsequently, the method of the present disclosure takes pictures of different projected images of the 3D models at twenty vertexes of the regular dodecahedron. The analyzed data which is formed by taking pictures as mentioned above are called data global features. The data global features are capable of presenting projected conditions of a rigid-body object in different viewpoints.

After different projected images of the 3D models of data images are obtained, the method of the present disclosure obtains the data global features correspondingly based on the projected images. In one embodiment, the method of the present disclosure obtains the data global features of the projected images of the data images correspondingly by extracting features from and analyzing the projected images of the data images based on one of the Zernike moment, Histogram of Depth Gradient (HODG) and 2D polar Fourier, or a combination thereof.

After the global projected images of the 3D models of the data images are obtained, the method of the present disclosure obtains and divides the projected images of the data images into a plurality of local images. In one embodiment, the method of the present disclosure can analyze the projected images based on a Morphological operation. Subsequently, as shown in step 230, the method of the present disclosure obtains a main portion of each of the projected images of the data images. In addition, as shown in step 240, the method of the present disclosure obtains a branch portion of each of the projected images by removing the main portions from the projected images.

For example, the 3D model can be a human body model, but is not limited thereto. The method of the present disclosure can analyze different projected images of the human body model based on a Morphological operation. Subsequently, as shown in step 230, the method of the present disclosure can obtain the main body of the human image. Next, as shown in step 240, the method of the present disclosure can obtain limbs of the human image by removing the main body from the human image. In addition, since the limbs divided by a Morphological operation may be connected to each other, the divided image is further analyzed to separate each portion in a definite manner. Since the picture which is taken is a depth image, there are obvious depth differences at the boundary of two branches. Therefore, the method of the present disclosure further performs edge detection with respect to the divided main body image. Subsequently, an edge map is subtracted from the branch area, and the result of such operations can make sure that each portion is not connected to each other. In addition, the branch portions can be collected by a connected component technique, etc. Therefore, the main portion and the branch portion can be separated from the projected image. The divided data are referred to as data local features.

After the main portion and the branch portion of the projected images of the data images are obtained, the method of the present disclosure can obtain the data local features of the main portions and the branch portions of the data images correspondingly by extracting features from and analyzing the main portions and the branch portions of the projected images based on Zernike moment and/or 2D polar Fourier. Referring to step 250, after data global features and data local features are obtained, the method of the present disclosure can establish the off-line database based on the data global features and the data local features. The off-line database comprises a data global feature database and a data local feature database.

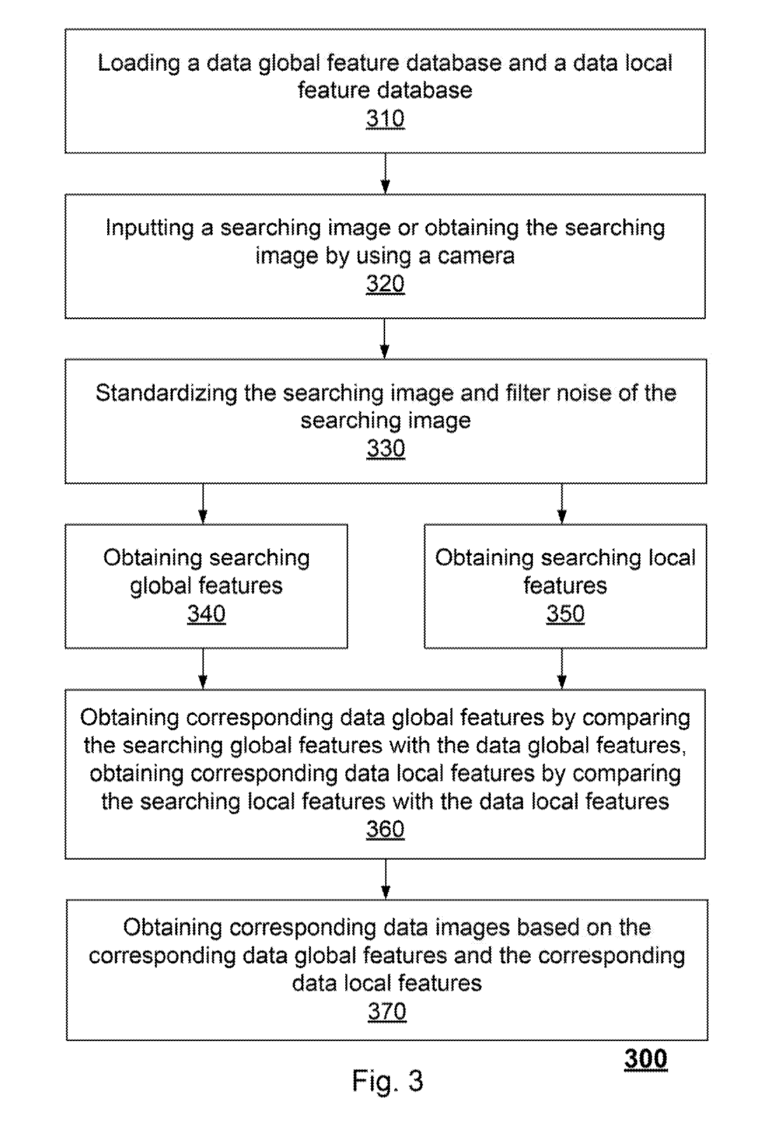

For facilitating understanding of how to let users search on-line based on the off-line database, reference is made to steps 120˜150 of FIG. 1 and FIG. 3. FIG. 3 is a flow diagram illustrating process steps of searching images of the method 100 for analyzing and searching images as shown in FIG. 1 according to embodiments of the present disclosure. First of all, referring to step 310, the method of the present disclosure loads the data global feature database and the data local feature database in advance. In step 120, when users perform a search process, the method of the present disclosure obtains the searching image which users input. As shown in step 320, users can input an image of an object to be the foregoing searching image, or an image of the foregoing object which is obtained by taking a picture of said object using a camera to be the foregoing searching image. In one embodiment, after obtaining the searching image, referring to step 330, the method of the present disclosure standardizes the searching image and filters noise of the searching image so as to increase accuracy of the searching result.

In step 130, the method of the present disclosure obtains searching global features and searching local features of the searching image by globally analyzing and locally analyzing the searching image respectively. In one embodiment, the method of the present disclosure analyzes a plurality of projected images of the searching image in different viewpoints. For example, the method of the present disclosure obtains 3D models comprised by the searching image, and places 3D models at a center of a regular polyhedron (i.e., a regular dodecahedron). Subsequently, the method of the present disclosure takes pictures of different projected images of the 3D models at a plurality of vertexes (i.e., twenty vertexes) of the regular polyhedron.

After different projected images of the 3D models of the searching image are obtained, the method of the present disclosure obtains a plurality of searching global features correspondingly based on the projected images. In one embodiment, referring to step 340, the method of the present disclosure can obtain the searching global features of the projected images of the searching images correspondingly by extracting features from and analyzing the projected images based on one of the Zernike moment, Histogram of Depth Gradient (HODG) and 2D polar Fourier, or a combination thereof.

After the global projected images of the 3D models of the searching images are obtained, the method of the present disclosure obtains and divides the projected images into a plurality of local images. In one embodiment, the method of the present disclosure can analyze the projected images based on a Morphological operation. Subsequently, the method of the present disclosure obtains a main portion of each of the projected images. In addition, the method of the present disclosure obtains a branch portion of each of the projected images by removing the main portions from the projected images.

After the main portion and the branch portion of the projected images of searching images are obtained, referring to step 350, the method of the present disclosure can obtain the searching local features of the main portions and the branch portions of the projected image correspondingly by extracting features from and analyzing the main portions and the branch portions of the projected images based on Zernike moment and/or 2D polar Fourier.

In step 140, the method of the present disclosure can obtain data global features from the data global feature database correspondingly, and obtain data local features from the data local feature database correspondingly based on the searching local features. In one embodiment, referring step 360, the method of the present disclosure can obtain the corresponding data global features whose difference with the searching global feature is the smallest by comparing the searching global features with the data global features stored in the data global feature database. In another embodiment, referring to step 360, the method of the present disclosure can obtain the corresponding data local features whose difference with the searching local features is the smallest by comparing the searching local features with the data local features stored in the data local feature database. For example, the method of the present disclosure can obtain the corresponding data local features by comparing the searching local features and the data local features stored in the data local feature database based on earth mover's distance (EMD). It is noted that, when it comes to the comparison of the local feature data, since a branch separating technique is inaccurate or a shielding effect will be generated in some viewpoints, the correct number of the branches of the database model is different from that of the input searching images. Therefore, the EMD technique is used herein. This technique can measure the distance between two sets. Through using such a technique, the problem of number inaccuracy of the branches can be solved, as can the problem of different portions of the searching images being inputted matching the same portion in the database.

Referring to step 150 and step 370, the method of the present disclosure can obtain the corresponding data images from data images stored in the database based on the corresponding data global features and the corresponding data local features. After obtaining the corresponding data global features and the corresponding data local features whose difference with the searching global feature and the searching local feature are the smallest by the foregoing technique, the data images which correspond to these features are the searching results. Subsequently, these searching results are provided to users, or the data images whose difference are the smallest are presented in sequence related to similarity for users to choose. For example, users input human body models, and the method of the present disclosure can analyze the human body models for obtaining the searching global features and the searching local features of the human body models. Subsequently, the features of the human body models are compared with the data global features and the data local features stored in the database so as to obtain the features whose difference are the smallest. The original data images which correspond to the features whose difference are the smallest are the searching results. The method of the present disclosure can not only perform a searching process and a comparing process by adopting global features, but also can perform a searching process and a comparing process by adopting local features. Therefore, even if the posture of the human body may be different, the method of the present disclosure can still obtain current searching results efficiently, thereby enhancing the accuracy of the searching results.

The above-described method for analyzing and searching images can be implemented by software, hardware, and/or firmware. For example, if an implementer determines that speed and accuracy are paramount, the implementer may opt for a mainly hardware and/or firmware implementation; if flexibility is paramount, the implementer may opt for a mainly software implementation; alternatively, the collaboration of software, hardware and firmware may be adopted. It should be noted that none of the above-mentioned examples is inherently superior to the other and shall be considered limiting to the scope of the present invention; rather, these examples can be utilized depending upon the context in which the unit/component will be deployed and the specific concerns of the implementer.

Further, as may be appreciated by persons having ordinary skill in the art, the steps of the method for analyzing and searching images are named according to the function they perform, and such naming is provided to facilitate the understanding of the present disclosure but not to limit the steps. Combining the steps into a single step or dividing any one of the steps into multiple steps, or switching any step so as to be a part of another step falls within the scope of the embodiments of the present disclosure.

In view of the above embodiments of the present disclosure, it is apparent that the application of the present invention has a number of advantages. The present disclosure is directed to a method for analyzing and searching images for solving the problem of searching results not being accurate due to using global features to analyze input data and compare with models stored in the database.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for analyzing and searching images, comprising:
obtaining a plurality of data global features and a plurality of data local features of a plurality of data images by globally analyzing and locally analyzing the data images respectively;
obtaining a searching image;
obtaining a searching global feature and a searching local feature of the searching image by globally analyzing and locally analyzing the searching image respectively;
obtaining a corresponding data global feature from the data global features based on the searching global feature, and obtaining a corresponding data local feature from the data local features based on the searching local feature; and
obtaining a corresponding data image from the data images based on the corresponding data global feature and the corresponding data local feature.

2. The method of claim 1, wherein obtaining the data global features and the data local features of the data images by globally analyzing and locally analyzing the data images respectively comprises:
obtaining and analyzing a plurality of projected images of the data images in different viewpoints;
obtaining the data global features of the data images correspondingly based on the projected images of the data images;
obtaining and dividing the projected images of the data images into a plurality of local images; and
obtaining the data local features of the data images correspondingly based on the local images of the data images.

3. The method of claim 2, wherein obtaining and analyzing the projected images of the data images in different viewpoints comprises:
placing 3D models comprised by the data images at a center of a regular polyhedron; and
taking pictures of different projected images of the 3D models at a plurality of vertexes of the regular polyhedron.

4. The method of claim 3, wherein obtaining the data global features of the data images correspondingly based on the projected images of the data images comprises:
obtaining the data global features of the projected images of the data images correspondingly by extracting features from and analyzing the projected images of the data images based on Histogram of Depth Gradient (HODG) and 2D polar Fourier.

5. The method of claim 4, wherein obtaining and dividing the projected images of the data images into the local images comprises:
obtaining a main portion of each of the projected images of the data images by analyzing the projected images of the data images based on a Morphological operation; and
obtaining a branch portion of each of the projected images of the data images by removing the main portions from the projected images of the data images.

6. The method of claim 5, wherein obtaining the data local features of the data images correspondingly based on the local images of the data images comprises:
obtaining the data local features of the main portions and the branch portions of the data images correspondingly by extracting features from and analyzing the main portions and the branch portions of the projected images of the data images based on Zernike moment.

7. The method of claim 6, wherein obtaining the searching global feature and the searching local feature of the searching image by globally analyzing and locally analyzing the searching image respectively comprises:
analyzing a plurality of projected images of the searching image in different viewpoints;
obtaining the searching global features of the searching image correspondingly based on the projected images of the searching image;
obtaining and dividing the projected images of the searching image into a plurality of local images; and
obtaining the searching local features of the searching image correspondingly based on the local images of the searching image.

8. The method of claim 7, wherein analyzing the projected images of the searching image in different viewpoints comprises:
placing 3D models comprised by the searching image at a center of a regular polyhedron; and
taking pictures of different projected images of the 3D models at a plurality of vertexes of the regular polyhedron.

9. The method of claim 8, wherein obtaining the searching global features of the searching image correspondingly based on the projected images of the searching image comprises:
obtaining the searching global features of the projected images of the searching image correspondingly by extracting features from and analyzing the projected images of the searching image based on Histogram of Depth Gradient (HODG) and 2D polar Fourier.

10. The method of claim 9, wherein obtaining and dividing the projected images of the searching image into the local images comprises:
obtaining the main portion of the projected images of the searching image by analyzing the projected images of the searching image based on a Morphological operation; and
obtaining the branch portion of the projected images of the searching image by removing the main portions from the projected images of the searching image.

11. The method of claim 10, wherein obtaining the searching local features of the searching image correspondingly based on the local images of the searching image comprises:
obtaining the searching local features of the main portion and the branch portion of the searching image correspondingly by extracting features from and analyzing the main portion and the branch portion of the searching image based on Zernike moment.

12. The method of claim 11, wherein obtaining the corresponding data global feature from the data global features based on the searching global feature, and obtaining the corresponding data local feature from the data local features based on the searching local feature comprises:
obtaining the corresponding data global features whose difference with the searching global feature is the smallest by comparing the searching global features with the data global features; and
obtaining the corresponding data local features whose difference with the searching local features is the smallest by comparing the searching local features with the data local features.

13. The method of claim 12, wherein obtaining the corresponding data local features whose difference with the searching local features is the smallest data local features by comparing the searching local features with the data local features comprises:
obtaining the corresponding data local features by comparing the searching local features with the data local features based on earth mover's distance (EMD).
